(19) United States
(12) Patent Application Publication
(10) Pub. No.: US 2020/0068378 A1
(43) Pub. Date: Feb. 27, 2020

(54) OPPORTUNISTIC USE OF DRS INSTANCES IN LTE-U STAND ALONE SYSTEMS

(71) Applicant: NOKIA TECHNOLOGIES OY, Espoo (FI)

(72) Inventors: Jari Petteri LUNDEN, Espoo (FI); Benoist Pierre SEBIRE, Tokyo (JP); Elena VIRTEJ, Espoo (FI); Lars DALSGAARD, Oulu (FI); Dmitry PETROV, Jyväskylä (FI)

(21) Appl. No.: 16/461,567

(22) PCT Filed: Nov. 18, 2016
(86) PCT No.: PCT/EP2016/078180

§ 371 Date: May 16, 2019

(51) Int. Cl. H04W 8/00; H04W 48/12; H04W 48/16; H04L 12/807; H04W 74/08; H04L 27/00

(52) U.S. Cl. CPC H04W 8/005; H04W 48/12; H04L 27/0006; H04L 47/27; H04W 74/0808; H04W 48/16

(57) ABSTRACT

There is provided a method comprising: causing an attempt to transmit discovery signal by an access point in a first discovery window, said access point having a discovery window schedule for the transmission of a plurality of respective discovery signals; and in response to successfully transmitting the discovery signal, causing at least one subsequent discovery window in said schedule to be used for data transmission or to be unused, instead of attempting to transmit a discovery signal.

### FIELD

The present application relates to a method, apparatus and system and in particular but not exclusively, to arrangements which may have application in multi-channel Listen-Before-Talk (LBT) arrangements for operation on unlicensed spectrum (sometimes referred to as licensed-assisted access (LAA)).

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3rd Generation Partnership Project (3GPP). The various development stages of the 3GPP LTE specifications are referred to as releases.

LTE in unlicensed spectrum (LTE-U) is a proposal for the use of LTE radio communications technology in the unlicensed spectrum, such as the 5 GHz band already populated by Wi-Fi devices. Stand-alone LTE-U has been proposed, for example in an LTE based system such as the MuLTEfire system proposed by the applicant. This operates on an unlicensed carrier without a supporting connection on a licensed carrier.

### SUMMARY OF THE INVENTION

In a first aspect, there is provided a method comprising comprising: causing an attempt to transmit discovery signal by an access point in a first discovery window, said access point having a discovery window schedule for the transmission of a plurality of respective discovery signals; and in response to successfully transmitting the discovery signal , causing at least one subsequent discovery window in said schedule to be used for data transmission or to be unused, instead of attempting to transmit a discovery signal.

In response to an unsuccessful attempt to transmit the discovery signal in the first discovery window, the method may cause in a next discovery window in said schedule an attempt to transmit another discovery signal.

In response to a successful attempt to transmit the discovery signal in said first discovery window of a set of discovery windows, the method may cause at least one of said remaining discovery windows in said set to be used for data transmission or be unused.

The discovery window schedule may comprise a plurality of sets of discovery windows.

The method may comprise, at least one of a number of discovery windows in a respective set, a duration of a discovery window in a respective set, and a duration of a gap between windows in a respective set has one of a plurality of different values.

The method may comprise, at least one of the number of discovery windows in a respective set, the duration of a discovery window in a respective set and the duration of a gap between windows in a respective set is dependent on one or more of: successful attempts to transmit said discovery signal, one or more properties of the access point, one or more conditions in a network and one or more properties of a receiver to which said access point is transmitting.

The number of discovery windows in a set may be higher when a rate of transmission attempts is higher and the number of discovery windows in a set is lower when the rate of transmission attempts is lower.

The method may comprise, that when there is no data to be transmitted the discovery signal transmitter enters a reduced power state.

The discovery window may be a discovery receive signal transmission window.

The discovery signal may comprise a demodulation reference signal.

The method may comprise, causing the attempt to transmit comprises determining if a channel is available and if said channel is available transmitting said discovery signal.

The method may comprise, determining if a channel is available comprises causing a listen before talk or clear channel assessment to be performed.

In another aspect, there is provided a method comprising: receiving at an apparatus of a user device, a discovery signal in a first measurement window, said user device having a measurement window schedule for the reception of a plurality of respective discovery signals; and in response to successfully receiving the discovery signal in the first measurement window, in a subsequent measurement window of said schedule receiving data other than said discovery signal or causing the user device to be in a relatively low power mode.

The method may comprise, a receiver of said user device enters the relatively low power mode.

The method may comprise, that said relatively low power mode comprises a discontinuous reception mode.

The method may comprise, that said relatively low power mode is for a predefined duration.

In another aspect there is provided a computer program comprising computer executable code which when run on at least one processor may be configured to cause the any of the above methods to be performed.

According to another aspect, there is provided an apparatus, said apparatus comprising at least one processor and at least one memory including computer code for one or more programs, the at least one memory and the computer code configured, with the at least one processor, to cause the apparatus at least to: cause an attempt to transmit discovery signal by an access point in a first discovery window, said access point having a discovery window schedule for the transmission of a plurality of respective discovery signals; and in response to successfully transmitting the discovery signal, cause at least one subsequent discovery window in said schedule to be used for data transmission or to be unused, instead of attempting to transmit a discovery signal.

The at least one memory and the computer code may be configured, with the at least one processor, to in response to an unsuccessful attempt to transmit the discovery signal in the first discovery window, cause in a next discovery window in said schedule an attempt to transmit another discovery signal.

The at least one memory and the computer code may be configured, with the at least one processor, to in response to a successful attempt to transmit the discovery signal in said first discovery window of a set of discovery windows, cause at least one of said remaining discovery windows in said set to be used for data transmission or be unused.

The discovery window schedule may comprise a plurality of sets of discovery windows.

At least one of a number of discovery windows in a respective set, a duration of a discovery window in a respective set, and a duration of a gap between windows in a respective set may have one of a plurality of different values.

At least one of the number of discovery windows in a respective set, the duration of a discovery window in a respective set and the duration of a gap between windows in a respective set may be dependent on one or more of: successful attempts to transmit said discovery signal, one or more properties of the access point, one or more conditions in a network and one or more properties of a receiver to which said access point is transmitting.

The number of discovery windows in a set may be higher when a rate of transmission attempts is higher and the number of discovery windows in a set is lower when the rate of transmission attempts is lower.

The at least one memory and the computer code may be configured, with the at least one processor, to when there is no data to be transmitted cause the discovery signal transmitter to enter a reduced power state.

The discovery window may be a discovery receive signal transmission window.

The discovery signal may comprise a demodulation reference signal.

The at least one memory and the computer code may be configured, with the at least one processor, to determine if a channel is available and if said channel is available transmitting said discovery signal.

The at least one memory and the computer code may be configured, with the at least one processor, to determine if a channel is available by causing a listen before talk or clear channel assessment to be performed.

According to another aspect, there is provided an apparatus in a user device, said apparatus comprising at least one processor and at least one memory including computer code for one or more programs, the at least one memory and the computer code configured, with the at least one processor, to cause the apparatus at least to: receive, a discovery signal in a first measurement window, said user device having a measurement window schedule for the reception of a plurality of respective discovery signals; and in response to successfully receiving the discovery signal in the first measurement window, in a subsequent measurement window of said schedule receive data other than said discovery signal or causing the user device to be in a relatively low power mode.

The at least one memory and the computer code may be configured, with the at least one processor, to cause a receiver of said user device to enter the relatively low power mode.

The relatively low power mode may comprise a discontinuous reception mode.

The relatively low power mode may be for a predefined duration.

According to another aspect, there is provided an apparatus, said apparatus comprising: means for causing an attempt to transmit a discovery signal by an access point in a first discovery window, said access point having a discovery window schedule for the transmission of a plurality of respective discovery signals; and in response to successfully transmitting the discovery signal, means for causing at least one subsequent discovery window in said schedule to be used for data transmission or to be unused, instead of attempting to transmit a discovery signal.

The mean for causing an attempt to transmit a discovery signal is for, in response to an unsuccessful attempt to transmit the discovery signal in the first discovery window, causing in a next discovery window in said schedule an attempt to transmit another discovery signal.

The mean for causing an attempt to transmit a discovery signal is for, in response to a successful attempt to transmit the discovery signal in said first discovery window of a set of discovery windows, causing at least one of said remaining discovery windows in said set to be used for data transmission or be unused.

The discovery window schedule may comprise a plurality of sets of discovery windows.

At least one of a number of discovery windows in a respective set, a duration of a discovery window in a respective set, and a duration of a gap between windows in a respective set may have one of a plurality of different values.

At least one of the number of discovery windows in a respective set, the duration of a discovery window in a respective set and the duration of a gap between windows in a respective set may be dependent on one or more of: successful attempts to transmit said discovery signal, one or more properties of the access point, one or more conditions in a network and one or more properties of a receiver to which said access point is transmitting.

The number of discovery windows in a set may be higher when a rate of transmission attempts is higher and the number of discovery windows in a set is lower when the rate of transmission attempts is lower.

The apparatus may be arranged when there is no data to be transmitted to cause the discovery signal transmitter to enter a reduced power state.

The discovery window may be a discovery receive signal transmission window.

The discovery signal may comprise a demodulation reference signal.

The apparatus may comprise means for determining if a channel is available and if said channel is available transmitting said discovery signal.

The means for determining if a channel is available may be for causing a listen before talk or clear channel assessment to be performed.

According to another aspect, there is provided an apparatus in a user device, said apparatus comprising means for receiving, a discovery signal in a first measurement window, said user device having a measurement window schedule for the reception of a plurality of respective discovery signals; and in response to successfully receiving the discovery signal in the first measurement window, in a subsequent measurement window of said schedule, said means for receiving is for receiving data other than said discovery signal or causing the user device to be in a relatively low power mode.

The apparatus may comprise means for receiving a receiver of said user device to enter the relatively low power mode.

The relatively low power mode may comprise a discontinuous reception mode. The relatively low power mode may be for a predefined duration.

According to another aspect, there is provided a method comprising: causing an attempt to transmit discovery signal by an access point in a first discovery window, said access point having a discovery window schedule for the transmission of a plurality of respective discovery signals, wherein at least one of a discovery window duration and discovery window frequency varies in dependence on a rate of successful transmission attempts.

According to another aspect, there is provided an apparatus, said apparatus comprising at least one processor and at least one memory including computer code for one or more programs, the at least one memory and the computer code configured, with the at least one processor, to cause the apparatus at least to: cause an attempt to transmit discovery signal by an access point in a first discovery window, said access point having a discovery window schedule for the transmission of a plurality of respective discovery signals, wherein at least one of a discovery window duration and discovery window frequency varies in dependence on a rate of successful transmission attempts.

According to another aspect, there is provided an apparatus comprising: means for causing an attempt to transmit discovery signal by an access point in a first discovery window, said access point having a discovery window schedule for the transmission of a plurality of respective discovery signals, wherein at least one of a discovery window duration and discovery window frequency varies in dependence on a rate of successful transmission attempts.

A computer program comprising program code means adapted to perform the method(s) may also be provided. The computer program may be stored and/or otherwise embodied by means of a carrier medium.

In the above, many different embodiments have been described. It should be appreciated that further embodiments may be provided by the combination of any two or more of the embodiments described above.

Various other aspects and further embodiments are also described in the following detailed description and in the attached claims.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram, of an example mobile communication device;

FIG. 3a shows an example of a current DTxW (DRS (demodulation reference signal) transmission window) structure;

FIG. 3b shows an embodiment in which opportunistic use of redundant DTxWs may is made;

FIG. 4 shows a method for controlling the opportunistic use of redundant DTxWs;

FIG. 5 shows a method of radio resource control RRC connection configuration;

FIG. 6 shows an example configuration of DTxWs;

FIG. 7 shows a method performed at a user equipment; and

FIG. 8 shows a schematic diagram of an example control apparatus;

### DETAILED DESCRIPTION

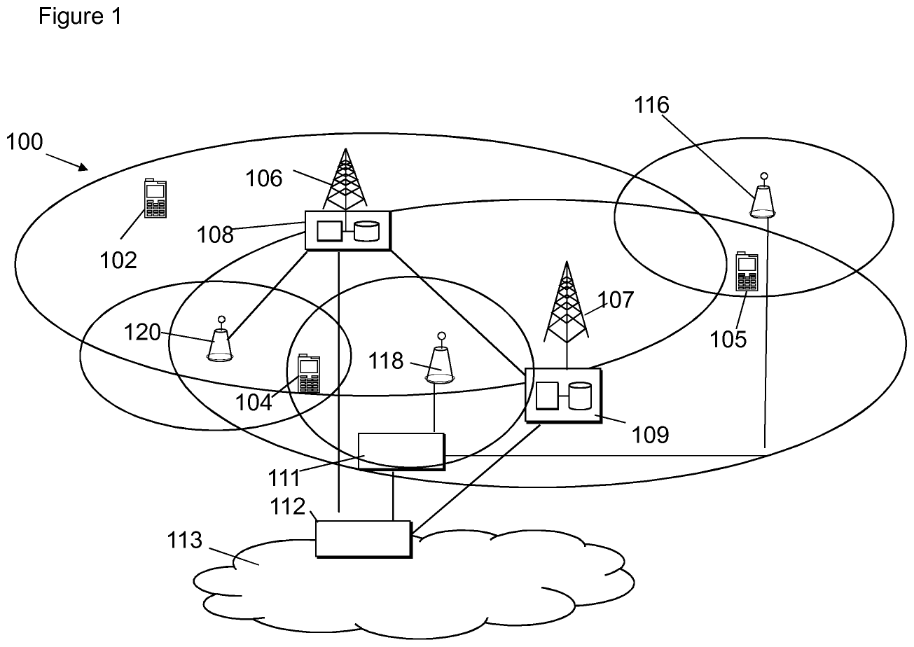

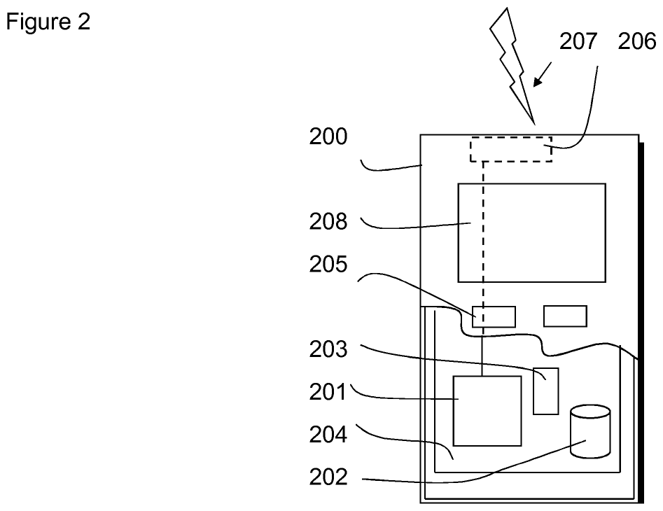

Before explaining in detail the examples, certain general principles of a wireless communication system and mobile communication devices are briefly explained with reference to FIGS. 1 to 2 to assist in understanding the technology underlying the described examples.

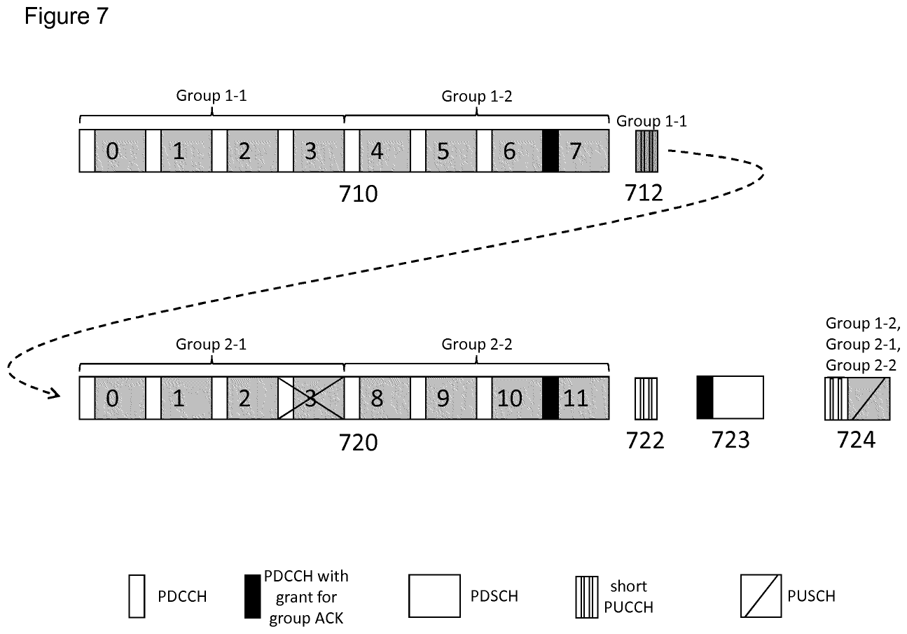

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller. The control apparatus may provide an apparatus such as that discussed in relation to FIG. 7.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on. Signalling mechanisms and procedures, which may enable a device to address in-device coexistence (IDC) issues caused by multiple transceivers, may be provided with help from the LTE network. The multiple transceivers may be configured for providing radio access to different radio technologies.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access). A base station can provide coverage for an entire cell or similar radio service area.

Wireless communication systems may be licensed to operate in particular spectrum bands. A technology, for example LTE, may operate, in addition to a licensed band, in an unlicensed band. Operating in an unlicensed band may be referred to as Licensed-Assisted Access (LAA). LTE-LAA may imply that a connection to a licensed band is maintained while using the unlicensed band. Moreover, the licensed and unlicensed bands may be operated together using, e.g., carrier aggregation or dual connectivity/multi-connectivity. For example, carrier aggregation between primary cell (PCell) on a licensed band and one or more secondary cells (SCells) on unlicensed band may be applied. In LTE LAA, the LAA downlink (DL) Scell may be configured for an UE as part of DL CA configuration, while the PCell uses licensed spectrum. Rel-13 LTE LAA may evolve to support LAA uplink (UL) transmissions on unlicensed spectrum in LTE Rel-14.

One objective may be to enhance LTE to enable licensed-assisted access to unlicensed spectrum while coexisting with other technologies and fulfilling regulatory requirements. In some jurisdictions, unlicensed technologies may need to abide by certain regulations, e.g. Listen-Before-Talk (LBT), in order to provide fair coexistence between LTE and other technologies such as Wi-Fi as well as between LTE operators.

The LTE LAA scenario discussed above, based on CA framework, may be based on the transmission of Uplink Control Information (UCI) on PCell (licensed band).

LAA with dual connectivity operation (i.e. assuming non-ideal backhaul between PCell in licensed spectrum and SCell(s) in unlicensed spectrum) and standalone LTE operation on unlicensed spectrum has been considered. LTE standalone operation on unlicensed spectrum means that eNB/UE air interface relies solely on unlicensed spectrum without any carrier on licensed spectrum. Both dual connectivity and standalone operation modes involve transmission of UCI/physical uplink control channel (PUCCH) on unlicensed spectrum.

In LTE-LAA, before being permitted to transmit, a user or an access point (such as eNodeB) may, depending on regulatory requirements, need to monitor a given radio frequency, i.e. carrier, for a short period of time to ensure the spectrum is not already occupied by some other transmission. This requirement is referred to as Listen-Before-Talk (LBT). The requirements for LBT vary depending on the geographic region: e.g. in the US such requirements do not exist, whereas in e.g. Europe and Japan the network elements operating on unlicensed bands need to comply with LBT requirements.

Unnecessary transmissions on unlicensed carriers, or channels, should be kept at a minimum level to avoid interfering other devices or access points operating on the same carrier frequency or preventing such devices from accessing the channel due to LBT requirements/operation. LBT requirements may mean that access points and UEs operating on an unlicensed carrier may need to stop transmission from time to time in order to give other nodes the chance to start their transmission as well (i.e. in order to provide fair co-existence) and in order to monitor whether the channel is still available. If a channel is still sensed as free according to LBT rules, the eNodeB or UE may resume transmission. If the channel is sensed as occupied (i.e. another node is transmitting on that channel), the eNodeB or UE will need to continue to suspend transmission until the channel is sensed as unoccupied according to LBT rules.

Some embodiments may be provided in LTE unlicensed (LTE-U) standalone systems (also known as MuLTEfire (MF)). In an MF system, the operation is such that there is no LTE licensed band assistance, i.e. in the MF Network (NW) cells operate on unlicensed frequency bands, without support from a licensed band. For now, this is envisioned in a synchronous NW, but in future this could take place alternatively or additionally in an asynchronous NW.

An issue with a standalone LTE-U is a consequence of the unreliability of getting access to the communication medium. This means that everything is subject to listen-before-talk (LBT), i.e. the eNB or UE cannot directly communicate with one another other (for example, as in an LTE licensed system), the eNB or UE have to apply LBT, in order to get access to the channel. Once the LBT is successful, then eNB/UE can use the transmission opportunity window (TxOp). Both the eNB and the UE are subject to LBT, for example, when the eNB has to transmit the discovery receive signals (DRS) for the UE, first the eNB has to obtain the channel and then transmit the DRSs. On the other hand, if for example the UE has to transmit a report in the UL, it has to succeed with the UL LBT first and then execute the normal LTE procedure for sending the report (for example, sending SR (scheduling request), getting the grant and then sending the report on the given resources).

Within the same synchronous MF NW, the UE knows the time instances when the eNB will transmit, for example, the timing of when the eNB is to transmit the DRS signals will be known to the UE. A DRS transmission window (DTxW) is defined, wherein an eNB may transmit DRS (that may contain one or more of Primary Synchronization Signal (PSS), Secondary Synchronization Signal (SSS), Cell-Specific Reference Signal (CRS), Channel State Information Reference Signal (CSI-RS), and/or System Information Block(s) (SIB)). As the system utilizes an LBT protocol, the success of the eNB sending the DRS signals is not guaranteed. For example, the transmission of signaling messages between the NW and the UE is subject to LBT.

Some embodiments take advantage of the scheduling by the eNB and utilize unused measurements or measurement opportunities (dynamic measurements).

When operating on an unlicensed carrier, an eNB may be configured with more DRS opportunities (sometimes referred to as DRS Transmission Windows (DTxW) or DRS Measurement and Timing Configuration (DMTC)) than may be necessary if there was no blocking due to LBT, due to the inherent unpredictability of such a network (i.e. it is not guaranteed that the eNB can access the medium and transmit within the configured window). As such, some DRS opportunities may be unused. Some embodiments allow the reuse of these unused DRS opportunities of the eNB for data transmission in order to increase data throughput.

DRS transmission blocking may occur due to LBT. The eNB may therefore configure DTxW (or DMTC) periodicity that is more frequent than the one required to ensure reliable measurements. For example, if a DTxW periodicity of 40 ms is required to establish reliable measurements, the eNB may configure the UE with a DMTC periodicity of 20 ms to overcome the possible DRS transmission blocking from LBT.

If the eNB is successful in the transmission of DRS (and possibly other broadcast signaling that the eNB may transmit together with DRS optionally with other information, in a first DTxW window (N), it may skip transmitting DRS in a second DTxW window (N+1) and instead it may schedule user data for transmission in the second DTxW window (N+1). The scheduled user data may still be subject to LBT. For example, this may be possible when the UEs successfully measure the DRS in window (N), wherein the DRS has a required or targeted periodicity of 40 ms, and wherein N+1 is 20 ms after window (N). If however, the eNB attempts to transmit DRS in window (N) are not successful, then the DRS may be transmitted again in DRS window (N+1). The DRS transmission in window (N+1) may or may not be successful due to LBT issues.

The other information transmitted with the DRS may comprise one or more of: Master Information Block (MIB) and enhanced System Information Block (eSIB). For example, in a MulteFire (MF) system, eSIB represents system information from SIB1 and SIB2 and may optionally provide additional information related to MF.

It should be appreciated that embodiments may include a plurality of DRS transmission windows and/or DRS periodicities. For example, the eNB may configure a DTxW periodicity of 20 ms, and only require DRS measurements every 80 ms. In this example, the eNB attempts to transmit the DRS in a DTxW if it has not successfully transmitted the DRS for 80 ms or more (i.e. during the previous 3 DTxWs).

For example, if the DRS is successfully transmitted in the first DTxW opportunity (N), the following three DTxW opportunities within the 80 ms period (N+1, N+2, N+3) may be used for scheduling user data; if the DRS is first successfully transmitted in the second DTxW opportunity (N+1), the following two DTxW opportunities within the 80 ms period (N+2, N+3) may be used for scheduling user data; if the DRS is first successfully transmitted in the third DTxW opportunity (N+2), the following one DTxW opportunity within the 80 ms period (N+3) may be used for scheduling user data; if only in the last DTxW opportunity (N+3), the DRS is successfully transmitted, there is no additional opportunity to schedule user data.

It should be appreciated that any suitable required DRS periodicity may be used. It should be appreciated that any suitable DTxW periodicity may be used.

Some embodiments may use other rules for determining whether the DRS transmission is to be attempted in a particular DTxW. For example, this may be determined based on a number M of successfully transmitted DRSs within a last number of DTxWs N, and if M is less than a threshold number T of DRSs, DRS transmission is attempted in the next DTxW. The values of N and T may be different, for example where N=5, and T=3. However, this is by way of example only and different values of N and T may be used. In some embodiments, N and T may have the same value.

In some embodiments the rule for determining whether the DRS transmission is to be attempted in a particular DTxW may be determined based on a time that it has taken since a last successful DRS transmission X, which may be compared to a threshold time Y. In some embodiments a DRS transmission may be attempted if the time taken since the last successful DRS transmissions X, has been longer than the threshold Y.

In some embodiments the eNB and UE may follow the same rule so that they, have the same understanding of whether there may be a DRS transmission attempt in a particular DTxW or DMTC.

In some situations there may be errors in the detection of DRS by the UE or there may be a mismatch that may cause the UE to unnecessarily attempt to measure during a DTxW or DMTC when the eNB does not attempt to transmit DRS. In some embodiments, such a mismatch may be corrected when successful DRS measurements are obtained. In some embodiments where there has been an error in the detection of DRS at the UE, the UE may assume that the eNB did not transmit DRS and perform additional measurement attempts and thus reduce the probability of missing further measurements. This may reduce the impact on measurement performance, and but still achieve some power saving.

Reusing the DTxW opportunity for user data may be fixed in specification or configured by the network, either through broadcast or dedicated signaling. The configuration may be dynamically configurable. For example, the configuration may be reactive to network requirements. The configuration (or rule) may specify a minimum number of consecutive DTxW opportunities that may be used to ensure reliable measurements.

The configuration (or rule) may specify whether scheduling of user data may be expected in the unused DTxW opportunities. After detecting that the minimum number of DTxW opportunities have been fulfilled, the UE may then know whether it may expect user data to be scheduled to increase throughput or switch off its receiver to increase battery saving.

In some embodiments, if LBT at an eNB succeeds, then the eNB sends DRS to enable UE to do measurements. At that point, UE will try to measure the DRS. RRM measurements are based on the DRS, which the UE performs according to the DMTC provided by the network (matching for example the DTxW of the serving cell). The event of a UE not detecting DRS transmissions shall be considered in RLF (radio link failure) triggering.

So, the eNB knows if it was able to transmit DRS. In the UE side there is some uncertainty as the UE may not know if DRS was not transmitted, or it was just unable to detect the transmission. So in both cases the UE could attempt to obtain additional measurement samples. If the eNB is not transmitting e.g. next time because it already succeeded previously, this attempt will be unsuccessful by the UE.

In some embodiments, the eNB may attempt to use all of the DRS transmission windows, regardless of whether the previous attempts were successful. UE may still be configured to skip some measurement opportunities (DRS transmission windows) in response to previous successful measurements. In some embodiments, the UE may be configured to measure at every configured DRS window regardless of the number of successfully obtained measurement samples, but the eNB may still omit attempting to transmit DRS in some of the windows in response to previous successful DRS transmissions.

A successful DRS transmission attempt by the eNB can mean that the eNB was able to transmit a DRS (or in some cases at least a part of the DRS) at least once within a transmission window. In practice this may mean that the LBT or CCA procedure was successful and the eNB was allowed to access the channel and transmit the DRS. A successful DRS transmission by the eNB may not necessarily mean that a UE or number of UEs were able to successfully receive or measure the DRS transmission.

A successful DRS reception by the UE can mean that the UE was able to receive the transmitted DRS at a signal strength or quality level that exceeds a configured or specified detection threshold. In some cases low signal strength or quality of the DRS transmission at the UE (for example due to long distance between the eNB and the UE) may cause UE to erroneously determine that there was no DRS transmitted even though it was; the signal strength or quality is just below the detection threshold. Other detection methods could be used by the UE as well to determine if there was a DRS transmission from the eNB.

In some embodiments, the UE determines its measurement schedule (i.e. in which DRS windows it attempts to measure) based on detected DRS transmissions from the serving cell or serving eNB. In some other embodiments, the UE may also determine the measurement schedule based on detected DRS from multiple cells or eNBs, for example if UE is dual connected or multi-connected to more than one eNB at the same time, or the UE is aggregated with cells on several carriers. The UE may apply a common measurement schedule for all the cells or carriers i.e. attempt to receive or measure DRS on all of the carrier or cells if it determines that it should attempt it in at least one of them (based on past successful or unsuccessful measurements), or it may determine the measurement schedule independently for each cell or carrier.

In some exemplary embodiments, the blocking rate may be observed from also other signals or transmissions than the DRS. Therefore, the blocking rate could consider other signals than DRS, or DRS outside the DMTC window for determining blocking rate. In an example embodiment, if UE receives frequent successful data transmissions or PDCCH transmission from the eNB, it may determine that the blocking rate is low even though the DRS reception was not successful.

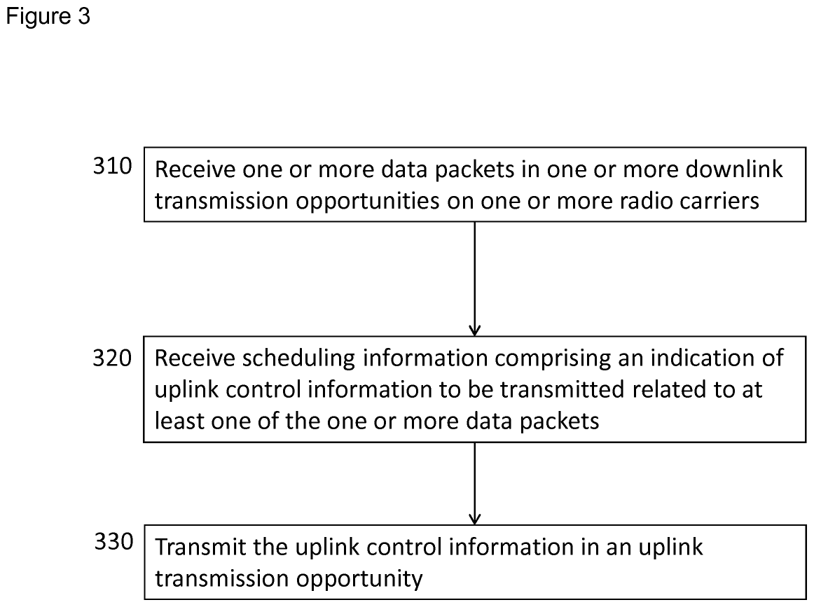

Reference is now made to FIGS. 3a and 3b. FIG. 3a shows an example of an unenhanced DTxW opportunity arrangement. In FIG. 3a the DTxW opportunity has a periodicity of N (415), for example 20 ms, and the DRS periodicity required to ensure reliable measurements is 2N, for example 40 ms. In a first DRS period, a successful DRS measurement of the UE is made at the first DTxW opportunity N (401). At the second DTxW opportunity N+1 (403) of the first DRS period, the CCA, and the DRS transmission fails. As the DRS periodicity required to ensure reliable measurements is 2N (40 ms), this condition is satisfied, and reliable measurements are maintained. In a second DRS period, at a first DTxW opportunity N (405), a successful DRS measurement of the UE is made, and at a second DTxW opportunity N+1 (407), of the second DRS period, a successful DRS measurement of the UE is also made. As the DRS periodicity required to ensure reliable measurements is 2N (40 ms), this condition is satisfied, and reliable measurements are maintained. In a third DRS period, at a first DTxW opportunity N (409), the CCA, and the DRS transmission fails, and at a second DTxW opportunity N+1 (411), of the third DRS period, a successful DRS measurement of the UE is also made. As the DRS periodicity required to ensure reliable measurements is 2N (40 ms), this condition is satisfied, and reliable measurements are maintained. A fourth DRS period continues with a first DTxW opportunity N (413).

In the above example of FIG. 3a, it can be seen that successful DRS measurements of the UE are made at DTxW opportunities 407 and 413 are made directly following successful DRS measurements of the UE made at DTxW opportunities 405 and 411. The successful DRS measurements of the UE made at DTxW opportunities 407 and 413 are therefore within the DRS period 2N (in this example the period of 40 ms), and as such are redundant.

Embodiments may make opportunistic use of such redundant DTxW opportunities by scheduling data transmission into these slots, when there is data in the data buffer of the eNB for the UE. For example, where the DTxW periodicity is N (20 ms) and a DRS periodicity required to ensure reliable measurements is 2N (40 ms), DTxW opportunities may only be used to transmit DRS every second DTxW opportunity, unless LBT blocked the first DTxW opportunity directly preceding the second DTxW opportunity.

FIG. 3b shows such an embodiment showing an enhanced DTxW opportunity arrangement. In FIG. 3b the DTxW opportunity has a periodicity of N (425), for example 20 ms, and the DRS periodicity required to ensure reliable measurements is 2N, for example 40 ms. In a first DRS period, a successful DRS measurement of the UE is made at the first DTxW opportunity N (421). At the second DTxW opportunity N+1 (423) of the first DRS period, the CCA, and the DRS transmission fails. As the DRS periodicity required to ensure reliable measurements is 2N (40 ms), this condition is satisfied, and reliable measurements are maintained. In a second DRS period, at a first DTxW opportunity N (425), a successful DRS measurement of the UE is made, and at a second DTxW opportunity N+1 (427), of the second DRS period, as the first DTxW opportunity N (425) was successful, a second DTxW opportunity (427) is used to schedule data transmission at the eNB for the UE if there is data in the buffer. As the DRS periodicity required to ensure reliable measurements is 2N (40 ms), this condition is satisfied, and reliable measurements are maintained. In a third DRS period, at a first DTxW opportunity N (429), the CCA, and the DRS transmission fails, and at a second DTxW opportunity N+1 (421), of the third DRS period, a successful DRS measurement of the UE is also made. As the DRS periodicity required to ensure reliable measurements is 2N (40 ms), this condition is satisfied, and reliable measurements are maintained. At DTxW opportunity 423 a successful UE measurement has been made at DTxW opportunity 421, within the DRS periodicity of 2N (40 ms), as such DTxW opportunity 423 can be used to schedule data transmission at the eNB for the UE if there is data in the buffer.

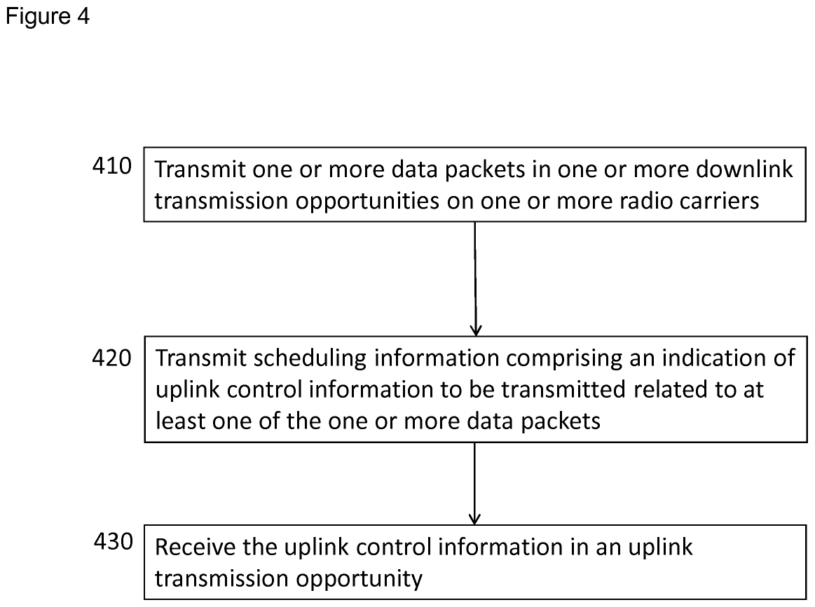

Reference is now made to FIG. 4 which shows an embodiment where a method of checking whether a DTxW opportunity may be used to transmit a DRS or whether that same DTxW opportunity may be used to schedule data transmission at the eNB for the UE if there is data in the buffer, based on whether a DRS has been successful within an allotted time period.

The method starts at a first logic block (501).

The arrangement is configured to have a DTxW periodicity N (503), for example 20 ms. This may be omitted in some embodiments.

The arrangement then waits to detect whether a DTxW opportunity is occurring. If a DTxW opportunity is not occurring then, the arrangement waits until a DTxW opportunity occurs (505).

If a DTxW opportunity is occurring then the arrangement calculates what period of time has elapsed since the last successful DRS measurement, and compares this time period with a pre-defined time period required to ensure reliable measurements to the UE N+1 (507), for example 40 ms.

If the time elapsed since the last successful DRS measurement is greater than or equal to the pre-defined time period required to ensure reliable measurements to the UE N+1, then the arrangement attempts to transmit DRS to the UE (509), subject to LBT, and the arrangement resumes waiting until a DTxW opportunity occurs (505).

If the time elapsed since the last successful DRS measurement is less than the pre-defined time period required to ensure reliable measurements to the UE N+1, the arrangement schedules user data to be transmitted to the UE if there is data in the data buffer (501), and the arrangement resumes waiting until a DTxW opportunity occurs (505).

Embodiments provide a UE, wherein if the eNB is successful in transmitting the DRS in the DTxW opportunity N (where there has been no LBT blocking), it may then assume that the UE is available, and is not required to make another measurement in the DTxW opportunity N+1 (for example, 20 ms later). However, if the eNB was not able to transmit the DRS in DTxW opportunity N, due to LBT blocking, it would know that the UE is required to be receiving a DRS measurement in DTxW opportunity N+1.

Embodiments may increase power efficiency in the UE, as only transmitting/receiving DRSs may in some cases consume less energy than transmitting/receiving data.

Embodiments may increase power efficiency in the UE, as the UE may receive the data in fewer windows or may enter a discontinuous transmission and/or receiving mode DRX/DTX.

Embodiments may reduce latency in the UE, as the UE gets a served more quickly, if it is not required to measure again at DTxW opportunity N+1.

Embodiments provide an eNB, wherein resources are better utilized, and data throughput is increased on the eNB side, as data scheduling opportunities are not missed.

Embodiments may reduce signaling overhead in the eNB, as the DRS may not be sent in the DTxW opportunity N+1.

Some embodiments may provide a system of switching between a higher periodicity of DTxW opportunities to a lower periodicity of DTxW opportunities.

In some embodiments a UE may transfer from a first domain that is licensed to a second domain that is unlicensed, for example a licensed assisted access (LAA) and MulteFire (MF). The licensed system (e.g. E-UTRAN) may be ported to the unlicensed domain and the necessary changes made to the licensed solution (E-UTRAN) in order to fulfil the basic requirements of the unlicensed system, for example, to ensure fair co-existence. One such rule which may be applied is the rule concerning LBT/CCA (Clear Channel Assessment), i.e. the eNB and UE has to sense the channel and evaluate if the channel is occupied or not. Only if the channel is sensed as not being occupied is access is allowed (both at the UE and eNB side).

LTE networks may provide continuous transmission of control information enabling the UE to detect and measure serving and neighbour cells. Porting such continuous transmission solution to an unlicensed band in which LBT/CCA is used as basic channel access scheme may not be possible without changes to the LTE. Some embodiments may provide a possible solution when operating in unlicensed domains, for example LAA or MulteFire, which is for the eNB to apply LBT to control information related to cell detection and measurements.

Embodiments may provide a UE which is able to perform more frequent DRS measurements when the UE experiences high eNB listen before talk (LBT), in terms of a high blocking rate of DTxW/DRS. When this is not the case, embodiments provide that the UE can rely on a lower DRS measurement frequency.

Embodiments may provide that when the UE experiences a high loss of DRS (i.e. a high downlink (DL) LBT failure rate and a high probability that DRS may not be received), the UE will increase the DRS measurement frequency, for example by decreasing the DRS periodicity from 40 ms to 20 ms. It should be appreciated that the use of the periods 20 ms and 40 ms are exemplary, and other values may be used.

Embodiments also provide that when the UE experiences that the LBT failure rate is lower than a threshold the UE use a lower DRS measurement frequency, for example by increasing the DRS periodicity from 20 ms to 40 ms. This may be, for example, reverting to a previous DRS periodicity.

Such behaviour may be configured by the network (NW) or it may be configured autonomously by the UE, for example with assistance from specifications. Such behaviour may be controlled using a first threshold setting that defines at which LBT failure rate the UE may increase the DRS measurement frequency and a second threshold setting that defines when the UE may revert to normal/non-increased, or reduced DRS measurement frequency. The first and second threshold settings may be the same or they may be different.

Embodiments provide that the UE could have a predefined baseline DRS measurement frequency, which may be a more relaxed DRS measurement frequency, for example having an interval period of 40 ms. This may allow the UE to skip some measurements. The measurement frequency may be increased once the LBT failure threshold is fulfilled. Such behaviour may be configurable or it may be specified as default behaviour (baseline behaviour).

Alternatively, embodiments provide that the UE may be required or assumed to make DRS measurements more frequently, as baseline, for example every 20 ms, and be allowed to reduce the measurement activity/frequency if the LBT failure rate (or DRS miss rate) is lower than a given limit or threshold.

In some embodiments the UE will determine the LBT failure probability threshold (and whether to use shorter or longer configured measurement interval). This may be achieved in one or more of the following ways.
Firstly, if the measurement does not succeed in specific DTxW occasion due to missed DRS instances due to LBT. There may be one occasion, or there may be several occasions.
Secondly, if the measurement does not succeed in N or more consecutive measurements.
Thirdly, if the measurement does not succeed in N or more measurements within a time window (for example, 200 ms).

This feature may be network (NW) configurable and there may be requirements for such a configuration. This feature may be supported by UE specified behavior as the NW may not rely only on UE implementation and there may be testable requirements for the UE measurements.

In some embodiments the UE is configured with DMTC opportunities at a period of N, for example 20 ms, but the UE may be allowed to omit half of the measurement occasions, equivalent to having a DMTC opportunity period of 2N, for example 40 ms. This may be possible, for example, if the UE is able to successfully measure the eNB when there is no LBT. However, if the UE does not obtain a measurement due to LBT on a DTxW/DMTC occasion, it may also measure the next one that it would otherwise omit.

Thus DTxW is eNB window time when it tries to transmit DRS, while DMTC is measurement window possibility for UE, configured by NW. DTxW and DMTC should be in sync (i.e. should be same or multiple of similar periodicities so that UE has indeed high rate of measuring the DRS). However in some cases that may not be true, e.g. if the network is only loosely synchronized so that DTxW of different eNBs is not fully aligned, the UE could be configured with a longer DMTC to cover the synchronization inaccuracy and thus have DTxW of all the cells on the carrier to fall within the DMTC configured to the UE.

In some embodiments this feature may be configured by the network using the measurement configuration. For example, once the network has configured the carrier, on which LAA or MuLTEfire is deployed, such configuration may include LBT failure thresholds and/or similar, enabling the UE how to react when a measurement threshold is not met. For example, if the LBT failure rate is below x% the UE may be allowed to relax the number of measurements.

In some embodiments the UE may be performing measurements at a period of N seconds, which may be tens of hundreds of milliseconds, wherein the DRS transmission window DTxW is L seconds, which may be tens of hundreds of milliseconds in duration, which may be configured by the network or by baseline behaviour of the system, for example a 6 ms DRS transmission window (DTxW) which has a periodicity of 40 ms.

When the UE is not able receive control information necessary for performing measurement in a first DTxW (DTxW_1), then the UE may make another measurement in another DTxW window (a second DTxW opportunity (DTxW_2)), after a time which is less than the regular measurement period N, for example 40 ms, so that the UE is measuring more often. For example, the second DTxW opportunity (DTxW_2) may be 20 ms after the first DTxW opportunity (DTxW_2) rather than the regular interval of N seconds, for example 40 ms.

In some example embodiments, if the eNB succeeded to transmit DRS in window N, it can skip transmitting DRS in window N+1 and instead try to schedule user data (still subject to LBT). Additionally, UE may perform more frequent measurement when the UE experiences high eNB LBT in terms of high blocking rate of DWxT/DRS. When this is not the case the UE can rely lower measurement frequency.

In some exemplary embodiments, if the eNB succeeded to transmit DRS in window N, it can skip transmitting DRS in window N+1 and instead try to schedule user data (still subject to LBT). Alternatively (or independently), UE may perform more frequent measurement when the UE experiences high eNB LBT in terms of high blocking rate of DWxT/DRS. When this is not the case the UE can rely lower measurement frequency.

It should be appreciated that the example values and implementations should not be seen as restrictive, but instead given in the context of LTE/MulteFire/LAA. In other systems, the ideas presented are applicable even though the exact naming of variables/procedures may differ. Similarly, the example implementations should not be taken as restrictive, and it should be appreciated that many variations of the example implementations are possible.

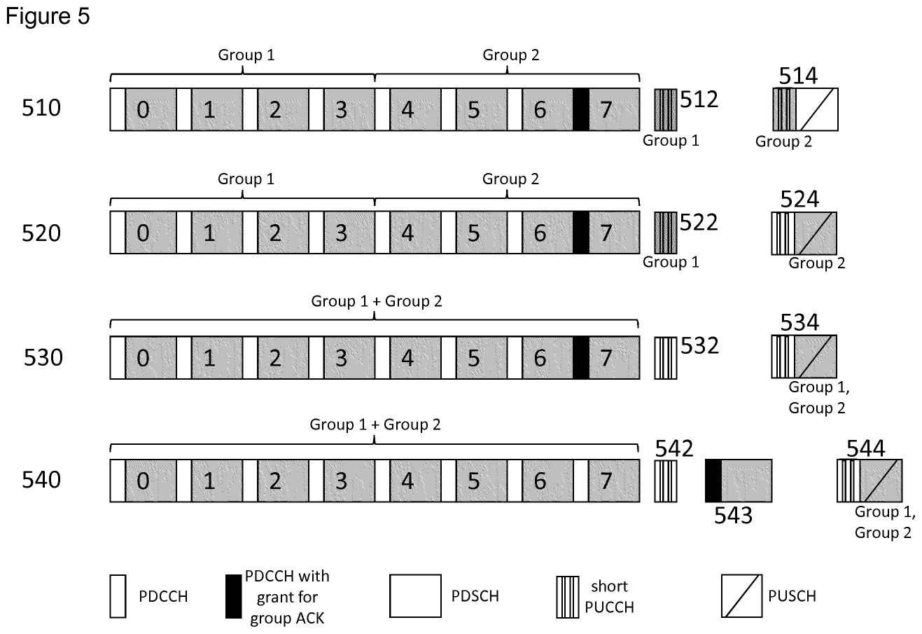

Reference is now made to FIG. 5 which shows a method of RRC connection reconfiguration.

At step 601, the method starts.

At step 603, the arrangement makes a first measurement (DTxW_1).

At step 605, it is decided whether the first measurement DTxW_1 was unsuccessful (LBT blocked). If the first measurement DTxW_1 was not unsuccessful, then the method reverts back to step 603, and the regular measurement period is maintained. If the measurement was unsuccessful, the regular measurement period is reduced and a second measurement (DTxW_2) is made in a time which is less than the regular time period from the first measurement (DTxW_1).

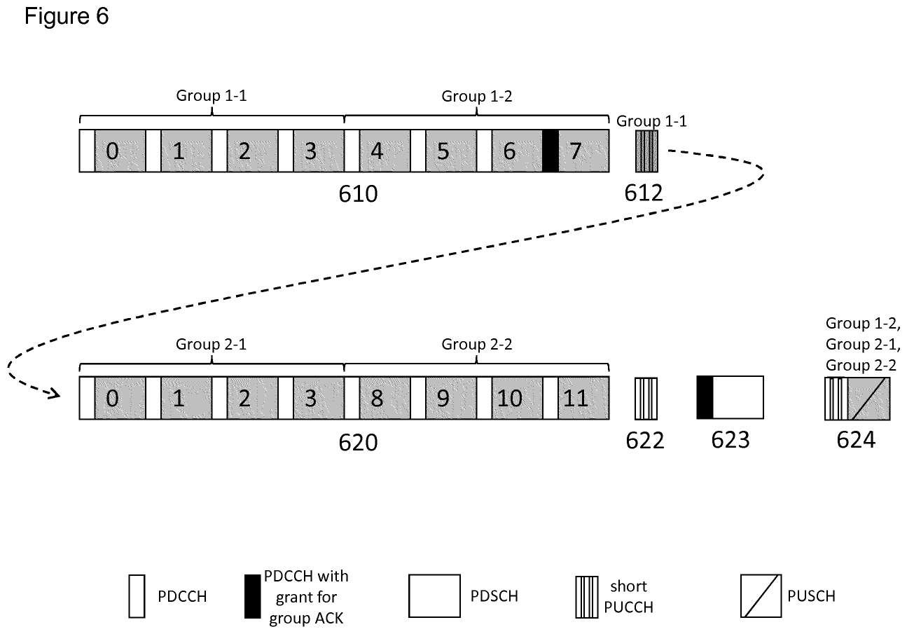

Reference is now made to FIG. 6 which shows an example configuration of several DTxW opportunities that support adaptive UE measurements. The periodicity of the first measurement opportunities DTxW_1 (701 and 705) is at an interval N, for example 40 ms. The periodicity of second measurement opportunities DTxW_2 (703 and 707) is at a time O after the first measurement opportunities DTxW_1 (701 and 705), for example 20 ms. For example, the second measurement opportunities DTxW_2 (703 and 707) are out of phase with the regular measurement intervals by a time duration O.

In some embodiments the second measurement opportunities DTxW_2 (703 and 707) are out of phase with the periodicity N by a duration of O, where O is equal to N/2. For example, where N is 80 ms, N/2 would be 40 ms. It should be appreciated that any appropriate duration may be used such that the second measurement opportunities occur more frequently than the first measurement opportunities where the measurements are unsuccessful. It should be appreciated that durations longer than the period of the first measurement opportunities may also be used, where it is determined that the frequency of measurements may be relaxed as discussed above.

In an alternative embodiment, the UE is configured to perform a regular measurement at a given interval N, for example where N is 40 ms. The UE may be aware of a DTxW opportunity at a time O after the regular measurement at a given interval N, for example where O is 20 ms. If the UE experiences a number of unsuccessful measurement attempts, for example where the eNB LBT prevents the eNB from transmitting DTxW, the UE may change the measurement interval from N (for example 40 ms) to another measurement at an interval O after the regular measurement (for example 20 ms). If after a given time, the UE is again able to perform successful measurements at interval N, the UE may revert to using the measurement interval N. For example, the UE may revert to the use of a measurement with a periodicity of 40 ms and not 20 ms.

According to the 3GPP LTE specification TS 36.331, measure discovery signal configuration (MeasDS-Config) information elements (IE) specifies information applicable for discovery signals measurement. This refers to an LTE specification, and as such MuLTEfire may deviate to some degree.

MeasDS-Config information elements from LTE specification TS 36.331.

-- ASN1START

| | |
|---|---|
| MeasDS-Config-r12 ::= | CHOICE { |

| | |
|---|---|
| release | NULL, |
| setup | SEQUENCE{ |
| dmtc-PeriodOffset-r12 | CHOICE { |
| m540-r12 | INTEGER(0..39), |
| m580-r12 | INTEGER(0..79), |
| m5160-r12 | INTEGER(0..159), |
| ... | |
| }, | |
| ds-OccasionDuration-r12 | CHOICE { |
| durationFDD-r12 | INTEGER(1..maxDS-Duration-r12), |
| durationTDD-r12 | INTEGER(2..maxDS-Duration-r12) |
| }, | |
| measCSI-RS-ToRemoveList-r12 | MeasCSI-RS-ToRemoveList-r12 |
| OPTIONAL, -- Need ON | |
| measCSI-RS-ToAddModList-r12 | MeasCSI-RS-ToAddModList-r12 |
| OPTIONAL, -- Need ON | |
| ... | |
| } | |
| } | |

Reference is now made to FIG. 7 which shows an example method of implementation of an embodiment at the UE. This in one example only and in the context of a current LTE specification.

In step 901, whenever the UE has a measure configuration (measConfig), the UE performs RSRP (Reference Signal Received Power), RSRQ (Reference Signal Received Quality) and RS-SINR (Reference Signal-Signal To Noise Ratio) (if indicated in an associated report configuration (reportConfig)) measurements for each serving cell as follows.

In step 902a, for the PCell, the UE applies the time domain measurement resource restriction in accordance with the measurement subframe pattern PCell (measSubframePatternPCell), if one is configured; in step 902b, if the UE supports CRS based discovery signal measurements.

In step 903a, for each SCell in a deactivated state, the UE applies the discovery signal measurement timing configuration in accordance with measure discovery signal configuration (measDS-Config), if configured within the measurement object (measObject) corresponding to the frequency of the SCell; in step 903b, if the received measObject includes measDS-Config.

In step 904, if measDS-Config is configured in the associated measObject.

In step 905, if measDS-Config includes a secondary DTxW.

In step 906, if the UE has not obtained a measurement since the start of the previous primary DTxW (DMTC).

In step 907a, the UE applies the secondary DTxW; else; in step 907b, the UE applies the primary DTxW.

The example implementation has been described using LTE specific terminology and style of notation, but it should be appreciated that it is not restricted to such terminology and notation only. According to TS 36.331 measDS-Config IE specifies information applicable for discovery signals measurement (note that is LTE spec, MuLTEfire and other standards or proposals may differ from this example.

An advantage of some embodiments, may be that a reduction of the impact of eNB LBT (when transmitting reference symbols such as DRS) on the UE measurement accuracy and mobility robustness. This may allow the benefits of shorter measurement periodicity to be utilized when it is needed whilst preventing an increase in the UE measurement burden when it is not necessary.

Using an adaptive DTxW periodicity may increase the failure rates (HOF (Handover Failure) and/or RLF (Radio Link Failure)). The increase may predominantly originate from one or more of the following two factors:
1) LBT blocking probability, and
2) measurement interval increase, for example from 20 ms to 40 ms.

In some embodiments the DTxW periodicity may be for example 40 ms for a MuLTEfire domain. If the LBT blocking probability increases (i.e. there is more load), then the DTxW periodicity may be adjusted to make more frequent measurements, for example using a DTxW periodicity of 20 ms. Increasing the UE measurement frequency may mean that the UE measurement activity will increase (as the measurement interval will be shortened).

It should be appreciated that the values given above are by way of example only and in different embodiments, any other suitable value may be use.

It may only be in some conditions that there is a need to increase the UE measurement frequency. Defining the UE measurements based on a worst case scenario may be one approach but it may have a significant impact on the UE, for example, an increase in power consumption. The scenarios that require additional measurement activity may be avoided in the scenarios where more frequent measurements may not be needed (for example, a background load case of 25% (i.e. where own network interference, is represented as percentage of resource blocks (RBs) in use on average)).

An advantage of some embodiments is providing methods and apparatus of providing optimized UE measurements such that the UE may only perform more frequent measurements when it is necessary. Embodiments may provide, a flexible but known and controllable increase of measurement activity on the UE side, in a scenario of high LBT blocking on the eNB side, only when it is needed.

In a fixed measurement interval arrangement: the UE may attempt to measure once every N ms. For example, 40 ms measurement interval may be enough in normal conditions. However, a 20 ms interval may provide a gain in performance when there is high load. Reducing the measurement interval increases the UE measurement effort as well as the DRS transmission overhead in eNB. For example, halving the measurement interval, may double the UE measurement effort as well as the DRS transmission overhead in eNB.

Some embodiments provide an adaptive measurement interval arrangement. For example, when there are no missed measurements due to LBT, for example, a 40 ms interval is used. When measurement occasions are missed (due to LBT failing), the next DRS transmission and measurement may be attempted in a shorter time (for example, 20 ms).

In some embodiments the adaptation may be tuned by selecting the length of the history that is used (for missed measurements).

It should be appreciated that embodiments can be implemented in both the UE and the network (NW) which may ensure robust mobility whilst not sacrificing the UE power consumption unnecessarily.

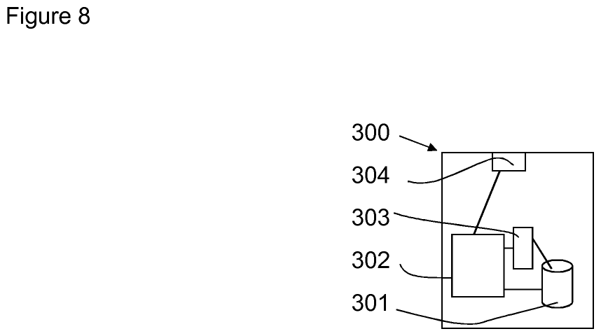

Embodiments described above by means of FIGS. 1 to 7 may be implemented on a control apparatus as shown in FIG. 8 or on a mobile device such as that of FIG. 2. FIG. 8 shows an example of a control apparatus for a communication system, for example to be coupled to and/or for controlling a station of an access system, such as a base station or (e) node B, or a server or host. In some embodiments, base stations comprise a separate apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 can be configured to execute an appropriate software code to provide the control functions. Control functions may include determining, at a first access point, whether a carrier from a plurality of carriers is a primary listen-before-talk carrier or a secondary listen-before-talk carrier and providing information using the carrier, said information comprising an indication of whether the respective carrier is a primary listen-before-talk carrier or a secondary listen-before-talk carrier.

Alternatively, or in addition, control functions may include receiving information from a first access point using a first carrier at a second access point, said information comprising an indication of whether the respective carrier is a primary listen-before-talk carrier or a secondary listen-before-talk carrier.

It should be understood that the apparatuses may include or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE, similar principles can be applied to any other communication system or radio access technology, such as 5G. In addition, although embodiments have been described from an LAA viewpoint, this disclosure may be equally valid for other co-existence scenarios. For example, Licensed Shared Access (LSA) is an example of a co-existence scenario. LSA is a spectrum sharing concept enabling access to spectrum that is identified for IMT but not cleared for IMT deployment. LSA may be focused on bands subject to harmonization and standardized by 3GPP (2.3 GHz in EU & China, 1.7 GHz and 3550-3650 MHz in US). Co-primary sharing is another example of a co-existence scenario. Co-primary sharing refers to spectrum sharing where several primary users (operators) share the spectrum dynamically or semi-statically. Co-primary sharing may be suitable e.g. for small cells at 3.5 GHz. Spectrum sharing between operators may happen if regulators require it and/or operators need it. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments as described above by means of FIGS. 1 to 9 may be implemented by computer software executable by a data processor, at least one data processing unit or process of a device, such as a base station, e.g. eNB, or a UE, in, e.g., the processor entity, or by hardware, or by a combination of software and hardware. Computer software or program, also called program product, including software routines, applets and/or macros, may be stored in any apparatus-readable data storage medium or distribution medium and they include program instructions to perform particular tasks. An apparatus-readable data storage medium or distribution medium may be a non-transitory medium. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), FPGA, gate level circuits and processors based on multi-core processor architecture, as non-limiting examples.

Embodiments described above in relation to FIGS. 1 to 9 may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method, comprising:
causing an attempt to transmit discovery signal by an access point in a first discovery window, said access point having a discovery window schedule for the transmission of a plurality of respective discovery signals; and
in response to successfully transmitting the discovery signal, causing at least one subsequent discovery window in said schedule to be used for data transmission or to be unused, instead of attempting to transmit a discovery signal.

2. The method of claim 1, further comprising, in response to an unsuccessful attempt to transmit the discovery signal in the first discovery window, causing in a next discovery window in said schedule an attempt to transmit another discovery signal.

3. The method of claim 1, further comprising, in response to a successful attempt to transmit the discovery signal in said first discovery window of a set of discovery windows, causing at least one of said remaining discovery windows in said set to be used for data transmission or be unused.

4. The method of claim 1, wherein the discovery window schedule comprises a plurality of sets of discovery windows.

5. The method of claim 4, wherein at least one of a number of discovery windows in a respective set, a duration of a discovery window in a respective set, and a duration of a gap between windows in a respective set, has one of a plurality of different values.

6. The method of claim 5, wherein at least one of the number of discovery windows in a respective set, the duration of a discovery window in a respective set and the duration of a gap between windows in a respective set, is dependent on one or more of:
successful attempts to transmit said discovery signal, one or more properties of the access point, one or more conditions in a network, and one or more properties of a receiver to which said access point is transmitting.

7. The method of claim 5, wherein the number of discovery windows in a set is higher when a rate of transmission attempts is higher, and the number of discovery windows in a set is lower when the rate of transmission attempts is lower.

8. The method of claim 1, wherein when there is no data to be transmitted, the discovery signal transmitter enters a reduced power state.

9. The method of claim 1, wherein said discovery window comprises a discovery receive signal transmission window.

10. The method of claim 1, wherein said discovery signal comprises a demodulation reference signal.

11. The method of claim 1, wherein the causing the attempt to transmit comprises determining if a channel is available, and if said channel is available, transmitting said discovery signal.

12. The method as claimed in claim 11, wherein determining if a channel is available comprises causing a listen before talk or clear channel assessment to be performed.

13. A method, comprising:
receiving, at an apparatus of a user device, a discovery signal in a first measurement window, said user device having a measurement window schedule for the reception of a plurality of respective discovery signals; and
in response to successfully receiving the discovery signal in the first measurement window, in a subsequent measurement window of said schedule receiving data other than said discovery signal or causing the user device to be in a relatively low power mode.

14. The method of claim 13, wherein a receiver of said user device enters the relatively low power mode.

15. The method of claim 14, wherein said relatively low power mode comprises a discontinuous reception mode.

16. The method of claim 13, wherein said relatively low power mode is for a predefined duration.

17. A non-transitory computer readable medium storing a program of instructions, execution of which by a processor configures an apparatus to at least perform the method of claim 1.

18. An apparatus, comprising:
at least one processor; and
at least one memory including a computer program code, the at least one memory and the computer program code configured to, with the at least one processor, cause the apparatus at least to:
cause an attempt to transmit discovery signal by an access point in a first discovery window, said access point having a discovery window schedule for the transmission of a plurality of respective discovery signals; and
in response to successfully transmitting the discovery signal, cause at least one subsequent discovery window in said schedule to be used for data transmission or to be unused, instead of attempting to transmit a discovery signal.

19. An apparatus in a user device, said apparatus comprising:
at least one processor; and
at least one memory including a computer program code, the at least one memory and the computer program code configured to, with the at least one processor, cause the apparatus at least to:
receive a discovery signal in a first measurement window, said user device having a measurement window schedule for the reception of a plurality of respective discovery signals; and
in response to successfully receiving the discovery signal in the first measurement window, in a subsequent measurement window of said schedule receive data other than said discovery signal or causing the user device to be in a relatively low power mode.

20. A non-transitory computer readable medium storing a program of instructions, execution of which by a processor configures an apparatus to at least perform the method of claim 13.
